(19) United States
(12) Patent Application Publication
(10) Pub. No.: US 2009/0036107 A1
(43) Pub. Date: Feb. 5, 2009

(54) METHOD, CALLEE STATION, AND COMMUNICATION SYSTEM FOR PERFORMING CALL TRANSFER FUNCTION

(75) Inventors: YU-ZHANG WEN, Shenzhen (CN); GENG-LIANG ZHANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/960,716

(22) Filed: Dec. 20, 2007

(30) Foreign Application Priority Data
Aug. 1, 2007 (CN) 200710201241.2

(51) Int. Cl. H04M 3/42; H04M 3/54

(52) U.S. Cl. 455/415; 379/212.01

(57) ABSTRACT

A method is provided for transferring an incoming call. The method includes determining whether the incoming call is answered or transferred, converting caller information of the incoming call in a first network to yield converted caller information in a second network for the incoming call being transferred is not answered, sending the converted caller information to a server in the second network, and checking the converted caller information stored in the server. Moreover, a callee station having a callee terminal, and a communication system are used for implementing the method.

### BACKGROUND

1. Field of the Invention

The present invention generally relates to methods for performing call transfer function, and particularly, to a method, a callee station, and a communication system using the same.

2. Description of Related Art

Communication terminals such as mobile phones are very common. Mobile phones allow users to communicate with each other according to a network standard.

Generally, call transfer and/or call forwarding functions are provided for the communication terminals. The call transfer and/or the call forwarding functions are a telecommunication mechanism that enables a user to redirect an incoming call to another communication terminal such as a fixed phone. Thus, when the communication terminal such as a mobile phone is powered off, incoming calls can be automatically forwarded to a fixed phone.

However, when users power off their phones, or if the battery is dead, and if users did not previously set the call forwarding service, the users may miss knowing about important incoming call attempts. Therefore, the currently used method and the current communication terminal thereof are not reliable.

Therefore, what is needed in the industry is to provide a method for collecting and storing caller information for users to communicate with each other more reliably, for example, providing data of important call attempts, a callee station having the communication terminal, and a communication system for implementing the method.

### SUMMARY

Accordingly, a method is provided for reliably recording caller information for unanswered incoming calls. The method includes determining whether the incoming call is answered directly or if the incoming call is forwarded to and answered by another terminal, or if the incoming call is not answered; converting caller information such as a caller phone number into e-mail compatible format, sending the formatted caller information to a mail server, and checking for the caller information in the mail server. Moreover, a callee station and a communication system are provided for implementing the method.

### BRIEF DESCRIPTION OF THE DRAWINGS

FIG. 1 illustrates a block diagram of a communication system, the communication system comprising a caller station, a communication network, and a callee station.

FIG. 2 illustrates a detailed block diagram of the communication system in FIG. 1.

FIG. 3 illustrates a mapping table for routing information in the communication system in FIG. 1.

FIG. 4 illustrates a flow chart of a collecting and storing caller information method using the communication system in FIG. 1.

### DETAILED DESCRIPTION

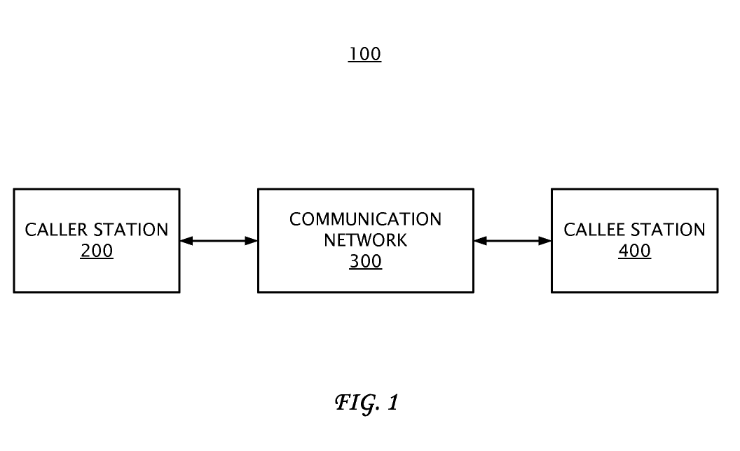

Referring to FIG. 1, a communication system 100 in accordance with an exemplary embodiment includes a caller station 200, a connection network 300, and a callee station 400. The caller station 200 and the callee station 400 are interconnected with each other by the connection network 300. The connections to the connection network 300 may be hard-wired connections, wireless connections, or combination thereof.

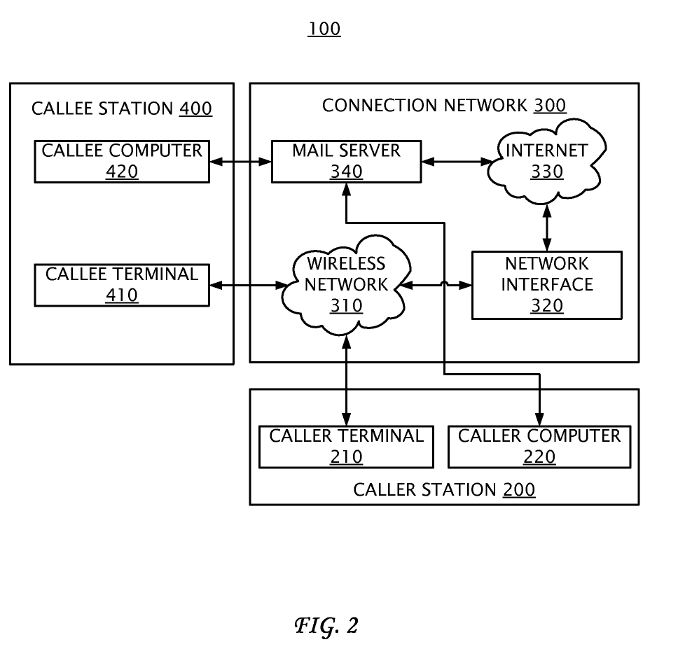

Referring to FIG. 2, the caller station 200 includes a caller terminal 210 and a caller computer 220. The callee station 200 includes a callee terminal 410 and a callee computer 420. The term “caller” herein is used to indicate a user who initiates a telephone call, whereas “callee” indicates an intended recipient of the telephone call. The caller terminal 210 and the callee terminal 410 may be any type of communication devices capable of telecommunicating, such as a fixed phone or a mobile phone. The caller terminal 210 and the callee terminal 410 are used for converting analog audio input to digital voice signals, and editing or displaying short messages. The digital voice signals or the short messages are sent via the connection network 300 from the caller terminal 210 to the callee terminal 410, or vice versa.

The connection network 300 includes a wireless network 310, a network interface 320, the internet 330, and a mail server 340. The wireless network 310 is used for establishing a wireless connection between the caller terminal 210 and the callee terminal 410. The network interface 320 is coupled between the wireless network 310 and the internet 330. The wireless network 310 may be a GSM, GPRS, or CDMA standard network and the internet 330 may be a TCP/IP telecommunication network. The network interface 320 is used for converting/formatting information, that is transferred between the wireless network 310 and the internet 330, to formats recognizable to each other. The mail server 340 is coupled to the caller computer 220 and the callee computer 420. The caller computer 220 and the callee computer 420 can receive e-mails from the mail server 340.

Details about operation of the communication system 100 will be described hereinafter. For example, a caller may use the caller terminal 210 to input a phone number to call a callee. If the callee does not answer after a predetermined number of rings, a call transfer function is automatically initiated, or enabled by the callee. The incoming call then is forwarded to a fixed phone for example. If the callee terminal 410 is powered on and within the reach of the providing network, and the callee answers, a wireless connection is established between the caller terminal 210 and the callee terminal 410. The caller and the callee can communicate with each other normally.

If the callee terminal 410 is powered off, the callee computer 220 may be used to collect the caller information.

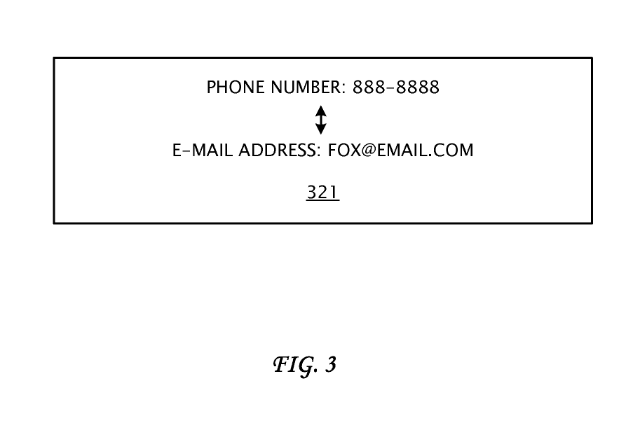

For example, the wireless network 310 collects the caller information including the caller number and calling time to the network interface 320. Referring to FIG. 3, the network interface 320 may, beneficially, further include a mapping table 321 stored therein. The mapping table 321 associates a plurality of caller numbers with a plurality of e-mail addresses respectively. For example, a phone number 888-8888 is associated with an e-mail address fox@email.com. The collected caller information is converted to an e-mail compatible format associated with an e-mail address. The formatted caller information is sent to the mail server 340 via the internet 330 by routing to the e-mail address. The callee computer 420 then may be used to login to the mail server 340 to check for e-mail having the caller information.

The callee computer 420 may be a portable type computer, so that the callee terminal 410 and the callee computer 420 may be carried together by the callee. In this situation, if the callee notices that the callee terminal 410 is not powered on or the battery is dead, the callee computer 420 may easily be checked for any caller information by e-mail.

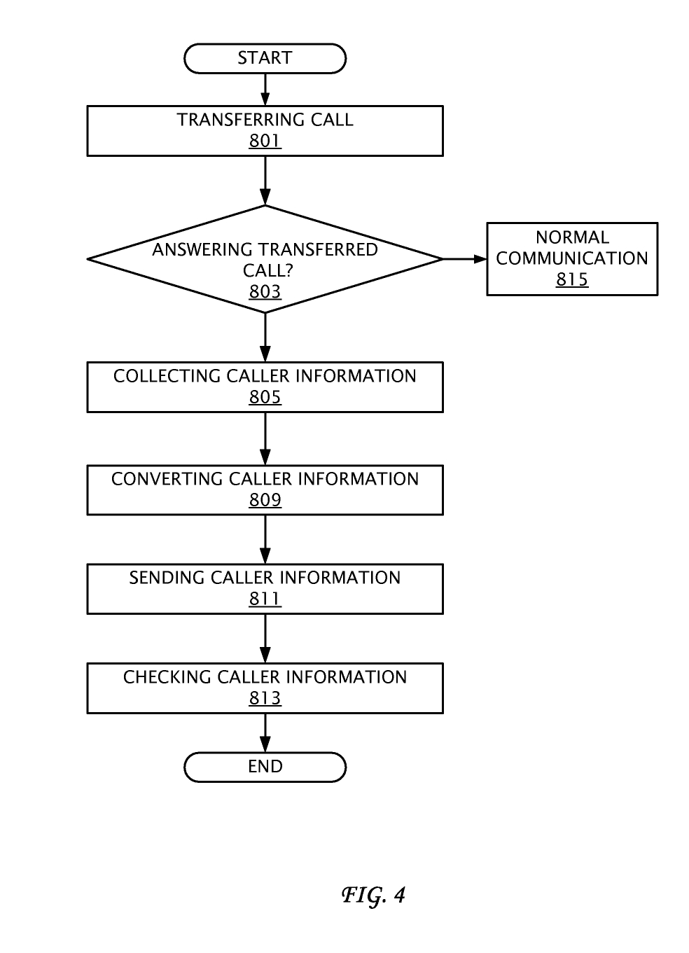

Referring to FIG. 4, a method 800 will be described hereinafter. In some embodiments, the method 800, or portions thereof, may be performed by the communication system 100 as described above, although the method 800 is not limited by the particular type of apparatus, software element, or system performing the call transfer method. The various actions in the method 800 may be performed in the order presented, or may be performed in a different order. Further, in some embodiments, some actions listed in FIG. 4 may be omitted from the method 800.

At block 801, a call transfer function is activated. For example, the call transfer function is activated when the caller number is not answered by a mobile phone.

At block 803, it is determined whether the transferred call is being answered by a fixed phone or not.

At block 815, if the call is answered by a fixed phone, normal communication ensues.

At block 805, if the call is not answered by a fixed phone, the caller information is collected. For example, the wireless network 310 collects the caller information such as the caller number and the calling time. The collected caller information is transferred to the network interface 320.

At block 809, the caller information is converted. For example, the network interface 320 converts the caller information to a format usable over the internet 330 such as that recognized by an email server 340.

At block 811, the converted caller information is sent. For example, the converted caller information is sent to a mail server 340 via the internet 330. The mapping table 321 of the network interface 320, associates a plurality of caller numbers with a plurality of e-mail addresses respectively. The converted caller information is transferred to the mail server 340 via the internet 330 by routing to the e-mail address.

At block 813, the converted caller information is checked by the callee via, for example, a laptop computer carried by the callee.

As the communication system 100 and the method 800 disclosed above, the user may communicate with each other more reliably. When the call transfer function is not feasible in some conditions, the caller information is converted to e-mail format caller information. The user then can use a computer to check for the e-mail format caller information. Therefore, a situation of missing important incoming calls is avoided.

Alternative embodiments will become apparent to those skilled in the art to which the present invention pertains without departing from its spirit and scope.

What is claimed is:

1. A method for communication comprising:
determining whether the incoming call is answered by a communication terminal;
determining whether the incoming call is transferred and answered by another communication terminal;
converting caller information of the incoming call in a first network to yield converted caller information recognizable in a second network;
sending the converted caller information to a server in the second network; and
checking the converted caller information in the server.

2. The method as claimed in claim 1, further comprising:
establishing a connection for normal communication when the incoming call is transferred.

3. The method as claimed in claim 1, wherein the first network is wireless network using GSM, GPRS, CDMA standard, etc., the second network is internet.

4. The method as claimed in claim 1, wherein the caller information is converted to e-mail format caller information.

5. The method as claimed in claim 4, further comprising:
routing the converted caller information to a server using a mapping table associating a number of the incoming calls with e-mail addresses of the server.

6. The method as claimed in claim 4, wherein a portable computer is used for checking the e-mail format caller information in the server.

7. A callee station for linking to a caller station via a connection network, the callee station comprising:
a callee terminal for receiving an incoming call from the caller station; and
a callee computer coupled to the callee terminal by the connection network, the callee computer for receiving e-mail format caller information converted from caller information of the incoming call for the incoming call being transferred is not answered by the callee terminal.

8. The callee station as claimed in claim 7, wherein the connection network comprises:
a network interface coupled between the callee terminal and the caller terminal, the network interface transforms the caller information to the e-mail format information.

9. The callee station as claimed in claim 8, wherein the network interface comprises:
a mapping table associating a calling number of the incoming call with an address of the e-mail format information.

10. The callee station as claimed in claim 7, wherein the callee terminal is a mobile phone.

11. The callee station as claimed in claim 7, wherein the callee terminal is a portable computer.

12. A communication system, comprising:
a caller terminal;
a callee terminal; and
a communication network coupled to the caller terminal and the callee terminal for establishing a connection between the caller terminal and the caller terminal, the communication network converting caller information of an incoming call from the caller terminal to e-mail format information for the incoming call being transferred is not answered by the callee terminal.

13. The communication system as claimed in claim 12, wherein the communication system further comprises:
a portable computer for checking for the e-mail information, the portable computer is carried together with the callee terminal.
